(19) United States
(12) Patent Application Publication
(10) Pub. No.: US 2024/0405260 A1
(43) Pub. Date: Dec. 5, 2024

(54) METHOD FOR PREPARING A COMPOSITE SOLID ELECTROLYTE WITH A SOFT FILLER

(71) Applicant: Beijing Institute of Technology, Beijing (CN)

(72) Inventors: Renjie CHEN, Beijing (CN); Nan CHEN, Beijing (CN); Binbin YANG, Beijing (CN)

(21) Appl. No.: 18/674,087

(22) Filed: May 24, 2024

(30) Foreign Application Priority Data
May 29, 2023 (CN) 202310611701.8

(51) Int. Cl. H01M 10/056; C08L 1/04; H01M 10/42

(52) U.S. Cl. CPC H01M 10/056; C08L 1/04; H01M 10/4235; H01M 2300/0065; H01M 2300/0091

(57) ABSTRACT

A method for preparing a composite solid electrolyte with a soft filler is provided. The soft filler is obtained by converting nanocellulose particles into lithiated cellulose, and it is a transparent cement-like composite material, and has lithium ion transfer and anion molecular sieve functions. The composite solid electrolyte is obtained by mixing a solvent, a polymer, a lithium salt and a lithiated cellulose. The lithiated cellulose has numerous oxygen-containing groups, and opens up a new transmission path of lithium ions in the composite solid electrolyte. Meanwhile, the lithiated cellulose can limit disordered movement of lithium salt anions, so that the transportation efficiency of lithium ions is improved. Researches find that lithiated cellulose strengthens various physical and chemical properties of the composite solid electrolyte. The composite solid electrolyte prepared by the method has the advantages of simple process, easily available raw materials, safety, no pollution and suitability for large-scale production.

### CROSS-REFERENCE TO RELATED APPLICATIONS

This application claims priority to Chinese application 202310611701.8, filed May 29, 2023, which is hereby incorporated by reference in its entirety.

### FIELD OF THE INVENTION

The present invention relates to a method for preparing a composite solid electrolyte with a soft filler, and belongs to the field of metal secondary batteries.

### BACKGROUND OF THE INVENTION

Lithium-ion batteries are commonly used in mobile electronic devices and new energy electric vehicles due to their excellent stability and high energy density. However, with the increasing human demand for high energy density and high safety energy storage technology, the development of new storage energy equipment is urgent. Lithium metal is considered to be the most promising alternative as a negative electrode of lithium-ion batteries due to its ultra-high theoretical capacity (3860 mAh g⁻¹), low mass density (0.534 g cm⁻³), and lowest electrochemical potential (−3.04V relative to standard hydrogen electrode). However, the organic electrolyte currently used in lithium-ion batteries is not stably compatible with metallic lithium and can easily form lithium dendrites, which can cause battery short circuits and even safety hazards (leakage and explosion). Therefore, changing the electrolyte form, broadening battery usage scenarios, and solving battery safety hazards have become the current research focus of lithium-ion batteries.

Solid electrolytes have attracted more and more attention due to their high mechanical strength, high safety and other characteristics that can effectively solve the existing problems with organic electrolytes. Generally, solid electrolytes can be divided into inorganic solid electrolytes, polymer solid electrolytes and composite solid electrolytes. Polymer electrolytes can have high ionic conductivity in the highly elastic state and outstanding flexibility, but their room temperature ionic conductivity is low, which severely limits their large-scale application. Inorganic solid electrolytes have high room temperature conductivity and good mechanical properties, but their interface contact performance is poor and their flexibility is low, so they have not been widely used. Adding different types of modified fillers to the polymer matrix can improve the room temperature ionic conductivity of the polymer while enhancing mechanical properties of the polymer matrix, thereby achieving the goal of inhibiting the growth of lithium dendrites and improving battery safety performance and energy density.

Therefore, the composite solid electrolyte that combines the advantages of polymer and inorganic electrolytes has the ability to inhibit the growth of lithium dendrites during solid battery cycle, while also improving battery safety and service life, which is of great significance for the development of the next generation of lithium batteries.

Many patents on composite solid electrolytes have been published, most of which use inert fillers that cannot conduct lithium ions (silica, titanium dioxide, etc.) and active fillers that can transport lithium ions (garnet, perovskite, etc.) to combine with polymers and lithium salts to prepare composite solid electrolyte. Since inorganic ceramic particles are prone to agglomeration and lack a stable lithium ion transport path, the electrochemical performance of this type of composite electrolyte cannot meet the requirements for operation at room temperature. In order to improve this type of composite solid electrolyte, there are also many research patents that add a small amount of electrolyte, plastic crystals or directly immerse them in the electrolyte to form gel or semi-solid electrolytes between the composite solid electrolyte and the positive and negative electrodes of the battery. However, the mechanical performance of this type of electrolyte is greatly reduced, and the growth of lithium dendrites cannot be effectively inhibited, resulting in a reduction in the battery cycle life. Therefore, it is urgent to explore new high-efficiency fillers, which is of great significance to the development of composite solid electrolytes.

### SUMMARY OF THE INVENTION

The present invention aims to provide a method for preparing a composite solid electrolyte with a soft filler by using lithiated cellulose that can transmit lithium ions and limit the movement of lithium salt anions as a soft filler. The composite solid electrolyte has good mechanical properties and interface chemical stability, high lithium ion conductivity and excellent electrochemical performance.

The object of the present invention is achieved through the following technical solutions:

A method for preparing a composite solid electrolyte with a soft filler, comprising adding a lithiated cellulose to a polymer slurry, stirring to obtain a composite solid electrolyte slurry, using a scraper to coat it to the glass plate and drying to obtain a composite solid electrolyte;

the polymer slurry is obtained by adding a polymer and a lithium salt into a solvent;

a molar concentration of the lithium salt is in a range from 0.125 mol/L to 0.5 mol/L; preferably 0.22 mol/L;

a mass ratio of the polymer to the solvent is in a range from 1:100 to 3:10; preferably 1:10;

a mass fraction of the lithiated cellulose content in the weight of the polymer does not exceed 8 wt %.

The method for preparing the polymer slurry is: adding the polymer and the lithium salt to the solvent and magnetically stirring overnight, the stirring time is controlled in a range from 6 hours to 36 hours, preferably 24 hours and the stirring rate is controlled in a range from 200 r/min to 1500 r/min, preferably 800 r/min.

A height of the scraper is in a range from 50 μm to 3000 um, preferably 1000 μm, the drying temperature is maintained in a range from 50° C. to 120° C., preferably 80° C., and the drying time is controlled in a range from 6 hours to 36 hours, preferably 24 hours.

The polymer is one or more of polyethylene oxide, polyvinylidene fluoride (PVDF), polyacrylonitrile, poly (vinylidene fluoride-co-hexafluoropropylene), polymethyl methacrylate, polyethylene glycol succinate, polypropylene oxide, polyethyleneimine and polyvinylidene chloride; preferably PVDF.

The lithium salt is one or more of lithium perchlorate, lithium bistrifluoromethylsulfonimide (LiTFSI), lithium bisfluorosulfonimide, lithium tetrafluoroborate, lithium hexafluoroarsenate and lithium hexafluorophosphate; preferably LiTFSI.

The solvent is one or more of N-methylpyrrolidone, N-N dimethylformamide, N-N dimethylacetamide (DMAc), triethyl phosphate, dimethyl sulfoxide, ethanol, methanol, acetonitrile and acetone, preferably DMAc.

A method for preparing a composite solid electrolyte with a soft filler comprises the following steps:
step 1: adding a nanocellulose particle into a DMAc solvent and stirring magnetically until the cellulose layer on the surface of the nanocellulose particle is detached; then centrifuging to obtain a wet pre-dissolved nanocellulose; drying to obtain a pre-dissolved nanocellulose particles; a mass ratio of the nanocellulose particle to the DMAc is in a range from 0.05 to 0.2, preferably 0.1;
step 2: adding anhydrous lithium chloride (LiCl) to the DMAc solvent and stirring until LiCl is completely dissolved to obtain a DMAc/LiCl solution; a molar ratio of LiCl/DMAc is in a range from 0:1 to 0.22:1, preferably 0.17:1;
step 3: adding the pre-dissolved nanocellulose particles obtained in step 1 to the DMAc/LiCl solution obtained in step 2, stirring evenly to obtain a lithiated cellulose; a mass fraction of the pre-dissolved nanocellulose particles is in a range from 4 wt % to 30 wt %, preferably 20 wt %.

In step 1, the stirring rate is controlled in a range from 200 r/min to 1500 r/min, preferably 800 r/min, and the stirring time is controlled in a range from 6 hours to 36 hours, preferably 24 hours.

In step 1, the centrifugal speed of the centrifugal separation is controlled in a range from 2000 r/min to 12000 r/min, preferably 10000 r/min.

In step 1, the drying temperature is maintained in a range from 50° C. to 120° C., preferably 80° C., and the drying time is controlled in a range from 6 hours to 36 hours, preferably 24 hours;

In step 2, the stirring rate is controlled in a range from 200 r/min to 1500 r/min, preferably 800 r/min, and the stirring time is controlled in a range from 6 hours to 36 hours, preferably 24 hours;

In step 3, the stirring rate of the stirring is controlled in a range from 200 r/min to 1500r/min, preferably 800r/min, and the stirring time is controlled in a range from 6 hours to 36 hours, preferably 24 hours.

The nanocellulose particle is one of various types of cellulose nanocrystals, cellulose nanofibers, cellulose nanosheets and nanocellulose particles which prepared and purified from trees, bamboo, hemp, cotton, crops, marine algae and marine bacteria, preferably nanocellulose particles prepared from cotton.

### Beneficial Effects

1. The lithiated cellulose prepared by the present invention removes the dense hydrogen bond structure inside the cellulose particles. Cellulose is dissolved in a solvent to obtain lithiated cellulose, which exposes numerous oxygen-containing groups. Lithiated cellulose can effectively promote the rapid migration of lithium ions in the composite solid electrolyte.
2. The lithiated cellulose prepared by the present invention can promote the dissociation of lithium salt and anchor lithium salt anions, thereby improving the efficiency of lithium ion transmission.
3. The composite solid electrolyte prepared by the present invention uses lithiated cellulose as the soft filler composite polymer and lithium salt, thereby avoiding the agglomeration of the filler and better reducing the crystallinity of the polymer to promote lithium ion transmission. The composite solid electrolytes obtained thereby have excellent electrochemical properties and are of great significance to the research and development of solid-state batteries.
4. The lithiated cellulose introduced in the present invention has good flexibility and can interact with the polymer substrate to promote the movement of polymer segments and greatly improve the ion transmission efficiency of solid-state batteries.
5. The present invention provides a highly safe composite solid electrolyte. The lithiated cellulose in the composite solid electrolyte not only improves the mechanical strength of the composite solid electrolyte and inhibits the growth of lithium dendrites, but also greatly promotes the ion transmission efficiency of the composite solid electrolyte, improves solid-state battery interface stability, and improves the performance of the metal secondary battery.
6. The present invention provides a composite solid-state electrolyte with excellent electrochemical properties. The composite solid electrolyte has ideal ionic conductivity, a wide electrochemical stability window and a high lithium ion transference number, and can significantly improve the cycle stability of solid lithium secondary battery.

### BRIEF DESCRIPTION OF THE DRAWINGS

FIG. 1 is an SEM image of a composite solid electrolyte having 1.5% lithiated cellulose.

FIG. 2 is an SEM image of a composite solid electrolyte having 5.5% lithiated cellulose.

FIG. 3 is an SEM image of a composite solid electrolyte having 7.2% lithiated cellulose.

FIG. 4 is an SEM image of a composite solid electrolyte having 8% lithiated cellulose.

FIG. 5 is an SEM image of a composite solid electrolyte without lithiated cellulose.

### DETAILED DESCRIPTION OF THE INVENTION

The present invention will be described in further detail below with reference to examples. However, the present invention is not limited to the following examples.

In the following examples, the analysis and testing methods used comprise:
AC impedance method test, electrochemical stability window test, lithium ion transference number test: electrochemical workstation (CHI660D), Shanghai;
Scanning electron microscope (SEM) test: Model HITACHI S-4800, Japan;
Solid electrolyte stress-strain test: INSTRON 3343, United States;
Electrochemical performance testing: LAND, Wuhan.

### Example 1

15 g of nanocellulose particles were added to 100 mL DMAc and stirred magnetically for 24 hours, followed by centrifugal separation at 10000 r/min, and then transferred to an 80° C. vacuum oven for drying for 12 hours to obtain pre-dissolved nanocellulose particles; a certain amount of anhydrous lithium chloride was added to the DMAc solvent until the anhydrous lithium chloride was completely dissolved and stirred for 24 hours, the molar ratio of anhydrous lithium chloride to DMAc solvent was maintained at 0.1:1 to obtain a DMAc/LiCl solution. 8 g of pre-dissolved nanocellulose particles were taken and added to 50 mL DMAc/LiCl solution and stired evenly to obtain lithiated cellulose. 0.8 g of PVDF and 0.22 mol/L of LiTFSI were added to 8 mL DMAc solvent and stirred magnetically for 24 hours, then lithiated cellulose with a PVDF mass fraction of 1.5% was added and the mixed solution was stirred for 24 hours to obtain a composite solid electrolyte slurry. The slurry was coated on the glass plate and placed in an 80° C. vacuum oven and dried for 24 hours to obtain the composite solid electrolyte. It was then transferred to a glove box filled with argon and dried on a heating plate at 80° C. for 12 hours for use.

The composite solid electrolyte with soft fillers prepared in this experimental example was tested. The results were as follows:
As shown in FIG. 1, the solid electrolyte prepared in this example has certain pores and the electrolyte is relatively flat, which is conducive to the rapid migration of lithium ions at the solid battery interface. The test shows that the conductivity of the solid electrolyte prepared in this example at 25° C. is 3.7×10⁻⁵/cm, the electrochemical window is in a range from 0 V to 4.4V (vs Li/Li⁺), and the lithium ion transference number is 0.55.

### Example 2

10 g of nanocellulose particles were added to 100 mL DMAc and stirred magnetically for 20 hours, followed by centrifugal separation at 10000 r/min, and then transferred to an 80° C. vacuum oven for drying for 20 hours to obtain pre-dissolved nanocellulose particles; a certain amount of anhydrous lithium chloride was added to the DMAc solvent until the anhydrous lithium chloride was completely dissolved and stirred for 24 hours, the molar ratio of anhydrous lithium chloride to DMAc solvent was maintained at 0.2:1 to obtain a DMAc/LiCl solution. 10 g of pre-dissolved nanocellulose particles were taken and added to 50 mL DMAc/LiCl solution and stired evenly to obtain lithiated cellulose. 1 g of PVDF and 0.22 mol/L of LiTFSI were added to 8 mL DMAc solvent and stirred magnetically for 24 hours, then lithiated cellulose with a PVDF mass fraction of 5.5% was added and the mixed solution was stirred for 24 hours to obtain a composite solid electrolyte slurry. The slurry was coated on the glass plate and placed in an 80° C. vacuum oven and dried for 24 hours to obtain the composite solid electrolyte. It was then transferred to a glove box filled with argon and dried on a heating plate at 80° C. for 12 hours for use.

The composite solid electrolyte with soft fillers prepared in this experimental example was tested. The results were as follows:

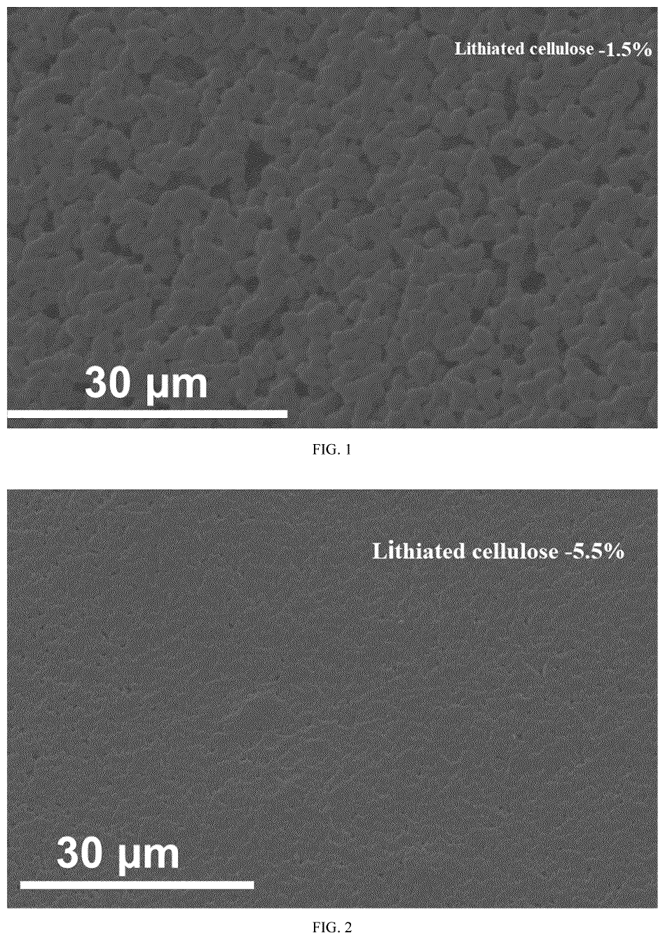

As shown in FIG. 2, the solid electrolyte prepared in this example has certain pores and the electrolyte is relatively flat, which is conducive to the rapid migration of lithium ions at the solid battery interface. The test shows that the conductivity of the solid electrolyte prepared in this example at 25° C. is 1.02×10⁻⁴S/cm, the electrochemical window is in a range from 0 V to 4.8V (vs Li/Li⁺), and the lithium ion transference number is 0.67. The solid lithium iron phosphate battery prepared using solid electrolyte with a soft filler can stably cycle for 300 times at room temperature and 0.5 C.

### Example 3

18 g of nanocellulose particles were added to 100 mL DMAc and stirred magnetically for 24 hours, followed by centrifugal separation at 10000 r/min, and then transferred to an 80° C. vacuum ovenfor drying for 24 hours to obtain pre-dissolved nanocellulose particles; a certain amount of anhydrous lithium chloride was added to the DMAc solvent until the anhydrous lithium chloride was completely dissolved and stirred for 24 hours, the molar ratio of anhydrous lithium chloride to DMAc solvent was maintained at 0.15:1 to obtain a DMAc/LiCl solution. 10 g of pre-dissolved nanocellulose particles were taken and added to 50 mL DMAc/LiCl solution and stired evenly to obtain lithiated cellulose. 0.8 g of PVDF and 0.22 mol/L of LiTFSI were added to 8 mL DMAc solvent and stirred magnetically for 24 hours, then lithiated cellulose with a PVDF mass fraction of 7.2% was added and the mixed solution was stirred for 24 hours to obtain a composite solid electrolyte slurry. The slurry was coated on the glass plate and placed in an 80° C. vacuum oven at and dried for 24 hours to obtain the composite solid electrolyte. It was then transferred to a glove box filled with argon and dried on a heating plate at 80° C. for 12 hours for use.

The composite solid electrolyte with soft fillers prepared in this experimental example was tested. The results were as follows:

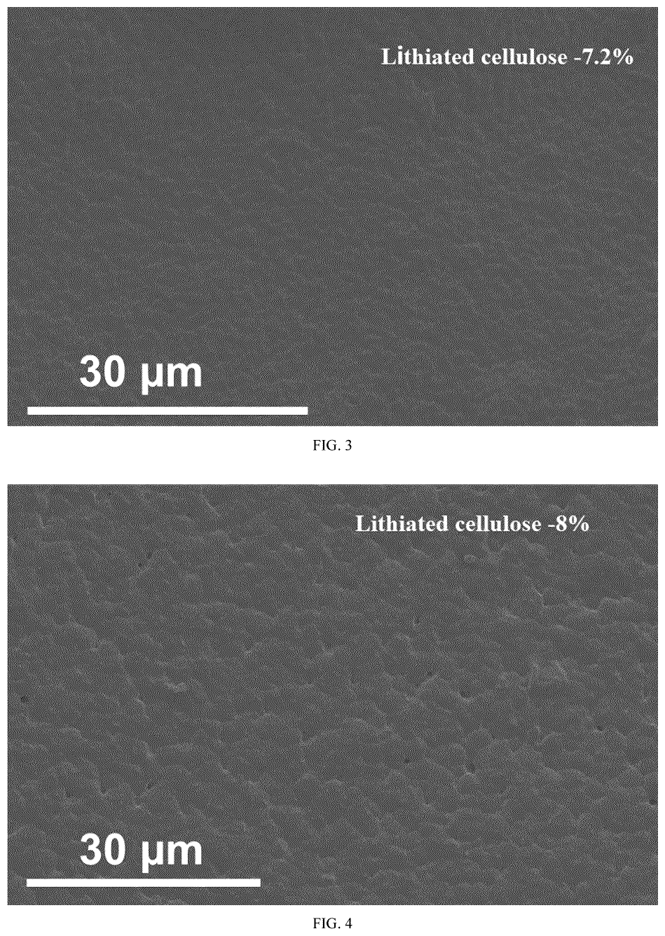

As shown in FIG. 3, the solid electrolyte prepared in this example has certain pores and the electrolyte is relatively flat, which is conducive to the rapid migration of lithium ions at the solid battery interface. The test shows that the conductivity of the solid electrolyte prepared in this example at 25° C. is 1.85×10⁻⁴S/cm, the electrochemical window is in a range from 0 V to 5.3V (vs Li/Li⁺), and the lithium ion transference number is 0.79. The solid lithium iron phosphate battery prepared using solid electrolyte with a soft filler can stably cycle for 500 times at room temperature and 0.5 C.

### Example 4

16 g of nanocellulose particles were added to 100 mL DMAc and stirred magnetically for 24 hours, followed by centrifugal separation at 10000 r/min, and then transferred to an 80° C. vacuum ovenfor drying for 24 hours to obtain pre-dissolved nanocellulose particles; a certain amount of anhydrous lithium chloride was added to the DMAc solvent until the anhydrous lithium chloride was completely dissolved and stirred for 24 hours, the molar ratio of anhydrous lithium chloride to DMAc solvent was maintained at 0.12:1 to obtain a DMAc/LiCl solution; 12 g of pre-dissolved nanocellulose particles were taken and added to 50 mL DMAc/LiCl solution and stired evenly to obtain lithium cellulose. 0.6 g of PVDF and 0.22 mol/L of LiTFSI were added to 8 mL DMAc solvent and stirred magnetically for 24 hours, then lithiated cellulose with a PVDF mass fraction of 8% was added and the mixed solution was stirred for 24 hours to obtain a composite solid electrolyte slurry. The slurry was coated on the glass plate and placed in an 80° C. vacuum oven and dried for 24 hours to obtain the composite solid electrolyte. It was then transferred to a glove box filled with argon and dried on a heating plate at 80° C. for 12 hours for use.

The composite solid electrolyte with soft fillers prepared in this experimental example was tested. The results were as follows:

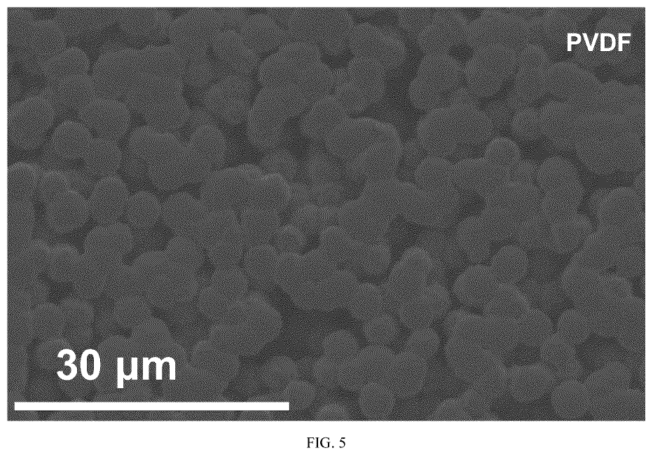

As shown in FIG. 4, the solid electrolyte prepared in this example has certain pores and the electrolyte is relatively flat, which is conducive to the rapid migration of lithium ions at the solid battery interface. The test shows that the conductivity of the solid electrolyte prepared in this example at 25° C. is 1.36×10⁻⁴S/cm, the electrochemical window is in a range from 0 V to 5.1V (vs Li/Li⁺), and the lithium ion transference number is 0.68. The solid lithium iron phosphate battery prepared using solid electrolyte with a soft filler can stably cycle for 400 times at room temperature and 0.5 C.

### COMPARATIVE EXAMPLE 1

0.8 g of PVDF and 0.22 mol/L of LiTFSI were added to 8 mL DMAc solvent and stirred magnetically for 24 hours to obtain a composite solid electrolyte slurry. The slurry was coated on the glass plate and placed in an 80° C. vacuum oven and dried for 24 hours to obtain the composite solid electrolyte. It was then transferred to a glove box filled with argon and dried on a heating plate at 80° C. for 12 hours for use.

The composite solid electrolyte with soft fillers prepared in this experimental example was tested. The results were as follows:

As shown in FIG. 5, the solid electrolyte prepared in this example has obvious pores, which is not conducive to the rapid migration of lithium ions at the solid-state battery interface. The test shows that the conductivity of the solid electrolyte prepared in this example at 25° C. is 4.7×10⁻⁶S/cm, the electrochemical window is in a range from 0 V to 4.3V (vs Li/Li⁺), and the lithium ion transference number is 0.16.

Although the present invention has been described in detail with general descriptions and specific embodiments above, it is obvious to those skilled in the art that some modifications or improvements can be made based on the present invention. Therefore, these modifications or improvements made without departing from the spirit of the present invention all fall within the scope of protection of the present invention.

1. A method for preparing a composite solid electrolyte with a soft filler, wherein the method comprises adding a lithiated cellulose to a polymer slurry, stirring to obtain a composite solid electrolyte slurry, and drying to obtain a composite solid electrolyte;
the polymer slurry is obtained by adding a polymer and a lithium salt into a solvent;
a mass ratio of the polymer to the solvent is in a range from 1:100 to 3:10;
a molar concentration of the lithium salt is in a range from 0.125 mol/L to 0.5 mol/L; and
a mass fraction of the lithiated cellulose content in the weight of the polymer does not exceed 8 wt %.

2. The method for preparing a composite solid electrolyte with a soft filler of claim 1, wherein the method for preparing the polymer slurry is: adding the polymer and the lithium salt to the solvent and magnetically stirring overnight, the stirring time is controlled in a range from 6 hours to 36 hours, and the stirring rate is controlled in a range from 200 r/min to 1500 r/min.

3. The method for preparing a composite solid electrolyte with a soft filler of claim 1, wherein the drying temperature is maintained in a range from 50° C. to 120° C., and the drying time is controlled in a range from 6 hours to 36 hours.

4. The method for preparing a composite solid electrolyte with a soft filler of claim 1, wherein the polymer is one or more of polyethylene oxide, polyvinylidene fluoride (PVDF), polyacrylonitrile, poly (vinylidene fluoride-co-hexafluoropropylene, polyethylene glycol succinate, polypropylene oxide, polyethyleneimine and polyvinylidene chloride;
the lithium salt is one or more of lithium perchlorate, lithium bistrifluoromethylsulfonimide (LiTFSI), lithium bisfluorosulfonimide, lithium tetrafluoroborate, lithium hexafluoroarsenate and lithium hexafluorophosphate;
the solvent is one or more of N-methylpyrrolidone, N-N dimethylformamide, N-N dimethylacetamide (DMAc), triethyl phosphate, dimethyl sulfoxide, ethanol, methanol, acetonitrile and acetone.

5. The method for preparing a composite solid electrolyte with a soft filler of claim 1, wherein the method for preparing the lithiated cellulose comprises the following steps:
step 1: adding a nanocellulose particle into a DMAc solvent and stirring magnetically until the cellulose layer on the surface of the nanocellulose particle is detached; then centrifuging to obtain a wet pre-dissolved nanocellulose; drying to obtain a pre-dissolved nanocellulose particles; a mass ratio of the nanocellulose particle to the DMAc is in a range from 0.05 to 0.2;
step 2: adding anhydrous lithium chloride (LiCl) to the DMAc solvent and stirring until LiCl is completely dissolved to obtain a DMAc/LiCl solution; a molar ratio of LiCl/DMAc is in a range from 0:1 to 0.22:1;
step 3: adding the pre-dissolved nanocellulose particles obtained in step 1 to the DMAc/LiCl solution obtained in step 2, stirring evenly to obtain a lithiated cellulose; a mass fraction of the pre-dissolved nanocellulose particles is in a range from 4 wt % to 30 wt %.

6. The method for preparing a composite solid electrolyte with a soft filler of claim 5, wherein in step 1, the stirring rate is controlled in a range from 200 r/min to 1500 r/min, and the stirring time is controlled in a range from 6 hours to 36 hours;
in step 1, the centrifugal speed of the centrifugal separation is controlled in a range from 2000 r/min to 12000 r/min;
in step 1, the drying temperature is maintained in a range from 50° C. to 120° C., and the drying time is controlled in a range from 6 hours to 36 hours;
in step 2, the stirring rate is controlled in a range from 200 r/min to 1500 r/min, and the stirring time is controlled in a range from 6 hours to 36 hours;
in step 3, the stirring rate of the stirring is controlled in a range from 200 r/min to 1500 r/min, and the stirring time is controlled in a range from 6 hours to 36 hours.

7. The method for preparing a composite solid electrolyte with a soft filler of claim 5, wherein the nanocellulose particle is one of various types of cellulose nanocrystals, cellulose nanofibers, cellulose nanosheets and nanocellulose particles which prepared and purified from trees, bamboo, hemp, cotton, crops, marine algae and marine bacteria.
